(19) United States
(12) Patent Application Publication
(10) Pub. No.: US 2022/0109987 A1
(43) Pub. Date: Apr. 7, 2022

(54) USING MOBILE DEVICE TO FULLY AUTOMATE ONBOARDING OF ROUTER

(71) Applicant: ARRIS Enterprises LLC, Suwanee, GA (US)

(72) Inventors: Akhtar Ghaus ZAMAN, Bangalore (IN); Muralidharan NARAYANAN, Bangalore (IN)

(21) Appl. No.: 17/404,077

(22) Filed: Aug. 17, 2021

Related U.S. Application Data
(60) Provisional application No. 63/088,731, filed on Oct. 7, 2020.

(51) Int. Cl. H04W 12/06; H04W 76/10; G06F 3/16; H04W 12/08

(52) U.S. Cl. CPC H04W 12/06; H04W 76/10; H04W 84/12; H04W 12/08; G06F 3/167

(57) ABSTRACT

Aspects of the present disclosure are drawn to a client device for use with a Wi-Fi access point device, an external network, and an external server. The Wi-Fi access point device has a secure SSID, a password, and a key and is configured to access the external network. The external server has the secure SSID, the password and the key stored therein. The client device includes a memory and a processor configured to execute instructions stored on the memory to cause the client device to transmit an onboarding instruction to the external server to instruct the external server to instruct the Wi-Fi access point device to establish a Wi-Fi network using the secure SSID, the password and the key.

### BACKGROUND

Embodiments of the present disclosure relate to onboarding wireless network devices.

### SUMMARY

Aspects of the present disclosure are drawn to a client device for use with a Wi-Fi access point device, an external network, and an external server. The Wi-Fi access point device has a secure SSID, a password, and a key and is configured to access the external network. The external server has the secure SSID, the password and the key stored therein. The client device includes a memory and a processor configured to execute instructions stored on the memory to cause the client device to transmit an onboarding instruction to the external server to instruct the external server to instruct the Wi-Fi access point device to establish a Wi-Fi network using the secure SSID, the password and the key.

In some embodiments, the processor is configured to execute instructions stored on the memory to additionally cause the client device to receive an indication from the external server of the established Wi-Fi network.

In some embodiments, the client device further includes a speaker, wherein the processor is configured to execute instructions stored on the memory to additionally cause the client device to play a sound, via the speaker, corresponding to the indication of the Wi-Fi network.

In some embodiments, the client device further includes a microphone, wherein the processor is configured to execute instructions stored on the memory. This additionally causes the client device to receive, via the microphone, a verbal instruction from a user to onboard the Wi-Fi access point device and transmit the onboarding instruction based on the received verbal instruction.

Other aspects of the present disclosure are drawn to a method of using a client device with a Wi-Fi access point device, an external network, and an external server. The Wi-Fi access point device has a secure SSID, a password, and a key and is configured to access the external network, the external server having the secure SSID, the password, and the key stored therein. The method includes transmitting, via a processor configured to execute instructions stored on a memory, an onboarding instruction to the external server to instruct the external server to instruct the Wi-Fi access point device to establish a Wi-Fi network using the secure SSID, the password and the key.

In some embodiments, the method further includes receiving, via the processor, an indication from the external server of the established Wi-Fi network.

In some embodiments, the method further includes playing, via a speaker, a sound corresponding to the indication of the established Wi-Fi network.

In some embodiments, the method further includes receiving, via a microphone, a verbal instruction from a user to onboard the Wi-Fi access point device and transmitting, via the processor, the onboarding instruction based on the received verbal instruction.

Other aspects of the present disclosure are drawn to a non-transitory, computer-readable media having computer-readable instructions stored thereon, the computer-readable instructions being capable of being read by a processor in a client device for use with a Wi-Fi access point device, an external network, and an external server. The Wi-Fi access point device has a secure SSID, a password, and a key and is configured to access the external network, the external server having the secure SSID, the password, and the key stored therein, wherein the computer-readable instructions are capable of instructing the processor to perform the method. The method includes transmitting, via the processor configured to execute instructions stored on a memory, an onboarding instruction to the external server to instruct the external server to instruct the Wi-Fi access point device to establish a Wi-Fi network using the secure SSID, the password and the key.

In some embodiments, the non-transitory, computer-readable media, wherein the computer-readable instructions are capable of instructing the processor to perform the method further includes receiving, via the processor, an indication from the external server of the established Wi-Fi network.

In some embodiments, the non-transitory, computer-readable media, wherein the computer-readable instructions are capable of instructing the processor to perform the method further includes playing, via a speaker, a sound corresponding to the indication of the established Wi-Fi network.

In some embodiments, the non-transitory, computer-readable media, wherein the computer-readable instructions are capable of instructing the controller to processor the method further includes receiving, via a microphone, a verbal instruction from a user to onboard the Wi-Fi access point device and transmitting, via the processor, the onboarding instruction based on the received verbal instruction.

### BRIEF SUMMARY OF THE DRAWINGS

The accompanying drawings, which are incorporated in and form a part of the specification, illustrate example embodiments and, together with the description, serve to explain the principles of the present disclosure. In the drawings:

FIG. 1 illustrates a conventional communication system onboarding a gateway device at a time to;

FIG. 2 illustrates an algorithm to be executed by a processor for onboarding a gateway device in accordance with aspects of the present disclosure;

FIG. 3A illustrates a communication system onboarding a gateway device at time t₁;

FIG. 3B illustrates communication system onboarding a gateway device at time t₂;

FIG. 4 illustrates an exploded view of a client device, a gateway device, and an external server of FIGS. 3A-B;

FIG. 5A illustrates a communication system onboarding a gateway device at time t₃;

FIG. 5B illustrates another embodiment of using the communication system of FIG. 5A for onboarding a gateway device at time t₄; and

FIG. 5C illustrates another embodiment of using the communication system of FIG. 5A for onboarding a gateway device at time t₅.

### DETAILED DESCRIPTION

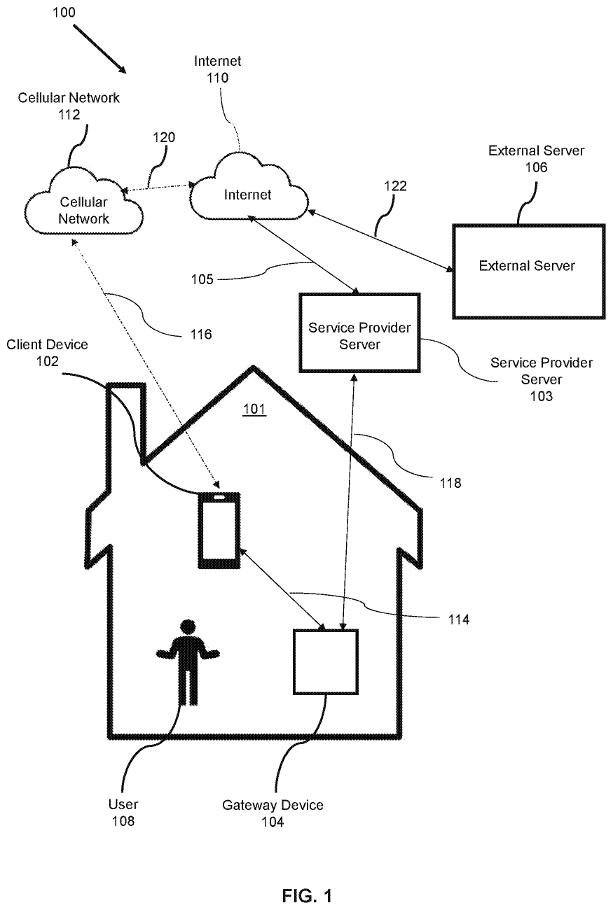

In a conventional system and method for onboarding a network device, a client device is used to facilitate the onboarding process. The client device, for example a smart phone, initiates the network device to start the onboarding process. Once the onboarding process is complete, the client device is able to connect to the wireless network via the network device. This conventional system will be described with reference to FIG. 1.

FIG. 1 illustrates a conventional communication system 100 onboarding a gateway device at a time to.

As shown in the figure, communication system 100 includes a residence 101, a client device 102, a service provider server 103, a gateway device 104, an external server 106, a user 108, an internet 110, a cellular network 112, a communication channel 105, a communication channel 114, a communication channel 116, a communication channel 118, a communication channel 120, and a communication channel 122.

Client device 102 is configured to communicate with internet 110 by way of a cellular network 112, an example of which is shown by communication channel 116. Client device is additionally configured to communicate with gateway device 104 via communication channel 114. Through gateway device 104, client device 102 is configured to communicate with internet 110 via communication channel 118. Through internet 110, client device 102 is additionally configured to communicate with external server 106 by way of communication channel 122. Gateway device 104 is configured to communicate with service provider server 103 via communication channel 118. Through service provider server 103, gateway device 104 is configured to communicate with internet 110 via communication channel 105. Through internet 110, gateway device 104 is configured to communicate with external server 106 via communication channel 122.

As illustrated in FIG. 1, gateway device 104, also referred to as a gateway, residential gateway, or RG, is an electronic device that is to be located so as to establish a local area network (LAN) at a user premises. The user premises may include a residential dwelling, office, or any other business space of a user. The terms home, office, and premises may be used synonymously herein.

Gateway device 104 may be any device or system that is operable to allow data to flow from one discrete network to another, which as will be described in greater detail below, will be from a wireless local area network (WLAN) to an external network, e.g., the Internet, which is shown as internet 110. Gateway device 104 may perform such functions as web acceleration and HTTP compression, flow control, encryption, redundancy switchovers, traffic restriction policy enforcement, data compression, TCP performance enhancements (e.g., TCP performance enhancing proxies such as TCP spoofing), quality of service functions (e.g., classification, prioritization, differentiation, random early detection (RED), TCP/UDP flow control), bandwidth usage policing, dynamic load balancing, and routing.

As will be described in greater detail below, gateway device 104 establishes, or is part of a WLAN, using Wi-Fi for example, such that client device 102, and any other device that may be connected, are able to communicate wirelessly with gateway device 104. The term Wi-Fi as used herein may be considered to refer to any of Wi-Fi 4, 5, 6, 6E, or any variation thereof.

Further, it should be noted that gateway device 104 is able to communicate with service provider server 103 via physical media/wiring 118, which may optionally be a wireless communication system, such as 4G, or 5G. Service provider server 103 is configured to connect gateway device 104 to external server 106 by way of communication channel 105, internet 110 and communication channel 122.

Within the WLAN, electronic devices are often referred to as being stations in the network. In IEEE 802.11 (Wi-Fi) terminology, a station (abbreviated as STA) is a device that has the capability to use the 802.11 protocol. For example, a station may be a laptop, a desktop PC, PDA, APD, or Wi-Fi phone. An STA may be fixed, mobile or portable. Generally, in wireless networking terminology, a station, wireless client, and node are often used interchangeably, with no strict distinction existing between these terms. A station may also be referred to as a transmitter or receiver based on its transmission characteristics. IEEE 802.11-2012 defines station as: A logical entity that is a singly addressable instance of a medium access control (MAC) and physical layer (PHY) interface to the wireless medium (WM).

Consider the following situation: user 108 has purchased gateway device 104 that they would like to onboard. Client device 102 may instruct gateway device 108 to initiate the onboarding process, meaning that gateway device 104 is put into a state where it may be used. Once onboarded, gateway device 104 may provide client device 102 with a connection to internet 110 through physical media/wiring 118, service provider server 103 and communication channel 105.

One limitation with the conventional onboarding process is that the onboarding process is open, and therefore not secure. Further, there may be instances wherein the network device should be re-onboarded, e.g., rebooted, for example in attempts to rectify faulty operations or when service upgrades are needed. These re-onboarding processes may be difficult and time consuming for the user, which may cause them to be frustrated with the multiple interaction points. Also, the user would be required to initiate these onboarding processes while in the home, as the client device would be required to be wirelessly connected to the network device. As such, the user would be unable to initiate onboarding of devices from outside of the home.

What is needed is a system and method for re-onboarding a currently onboarded network device using a programmed SSID remotely, or by way of a smart media device. A smart media device (SMD) combines multiple devices in a connected home—a set-top box, smart speaker, visual smart assistant, Internet of Things (IoT) hub and remote control—into a single device. In most cases an SMD includes a microphone to hear voice commands from a user, which may be used to activate functions of the SMD, and a speaker to play audible indications to the user.

In accordance with aspects of the present disclosure, a system and method is provided for re-onboarding a currently onboarded network device using a programmed SSID remotely, or by way of an SMD.

A system and method in accordance with the present disclosure allows a user to generate the programmed secure SSID which may be unique to the network device so it cannot be used for any other network device. Additionally, utilizing an SMD decreases the need for user interaction and time to onboard the network device. This system and method also allows for onboarding without needing to be within close proximity of the network device.

In accordance with the present disclosure, a system and method is provided to onboard a network device using a client device, an external server, as well as in some cases an SMD. In cases wherein an SMD is used, the SMD interacts with the network device via the external server when given direct voice commands by the user.

The client device may either connect to the network device locally while at home or connect to the external server remotely while not at home. In either of the cases, the same instructions would be provided to perform the onboarding process. In the case when the client device will be away from home and thus away from the SMD, the onboarding of the network device may be performed without direct voice commands to the SMD but instead from the client device.

One advantage of a system of the present disclosure is that the network device may be onboarded securely with very minimal user interaction needed. Another advantage is that the network device may be repeatedly onboarded using the previously programmed SSID and commands given to the SMD. The network device will not need to start from the factory default SSID, which may be known openly and therefore not secure. If the user prefers to start the onboarding process from the factory setting open onboarding SSID, they are able to do so using the client device. Additionally, the user is able to onboard the network device from outside the home if needed. Further, the complete process may be automated using the SMD voice commands.

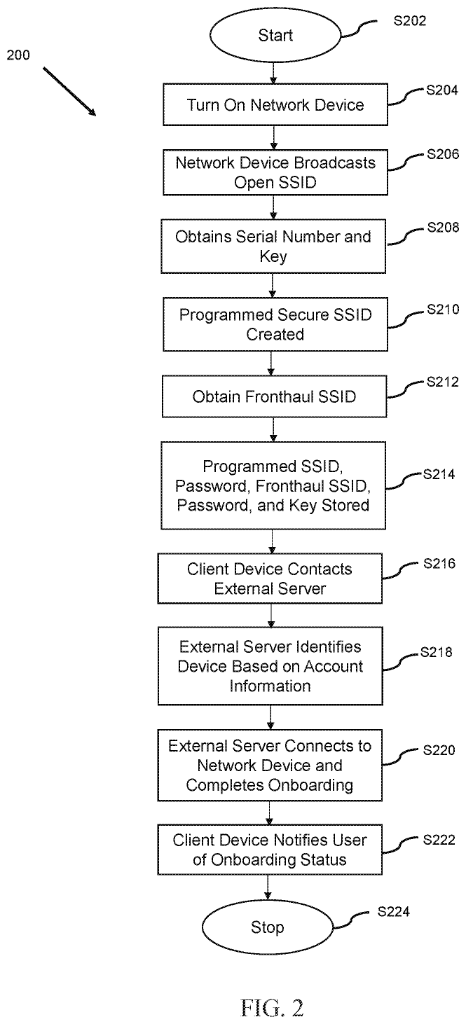

An example system and method for re-onboarding a currently onboarded network device using a programmed SSID remotely, or by way of an SMD in accordance with aspects of the present disclosure will now be described in greater detail with reference to FIGS. 2-5C.

Applicant Ref: 5012-US

For purposes of discussion, in an example embodiment discussed below, a gateway device is described as being onboarded. However, it should be noted that any network device may be used in accordance with aspects of the present disclosure.

FIG. 2 illustrates an algorithm 200 to be executed by a processor for onboarding a gateway device in accordance with aspects of the present disclosure.

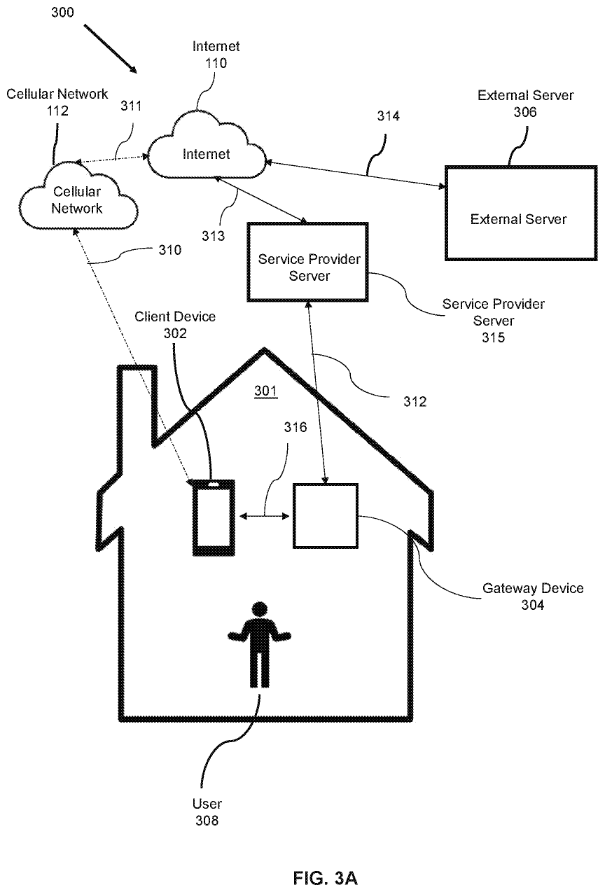

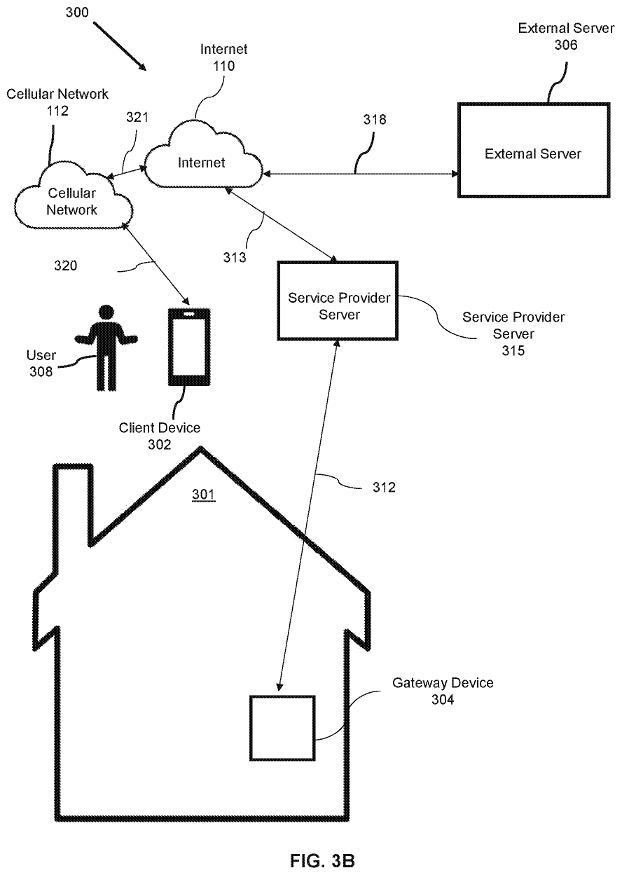

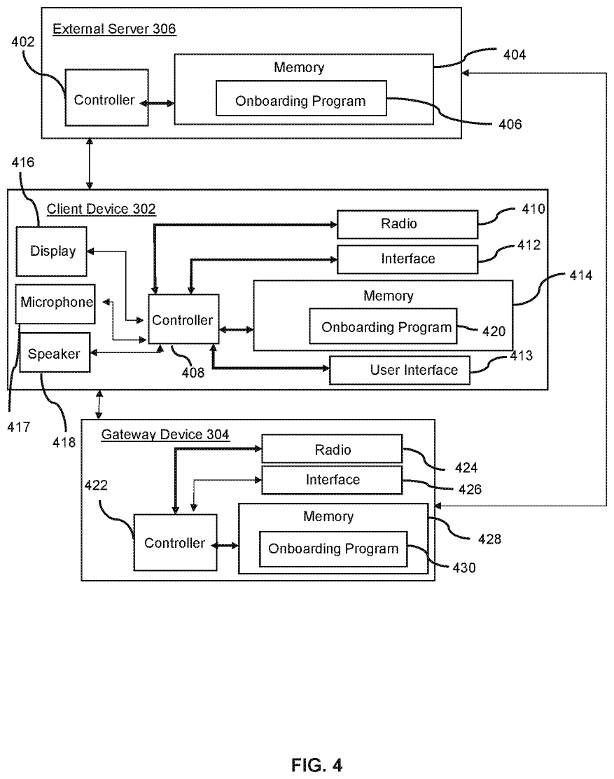

As shown in the figure, algorithm 200 starts (S202), and a user turns on the network device (S204). An example embodiment will be described in greater detail with reference to FIGS. 3A and 4.

FIGS. 3A-B illustrates onboarding of a new gateway device in accordance with aspects of the present disclosure, at times t₁ and t₂ respectively.

FIG. 3A illustrates a communication system 300 onboarding a gateway device at time wherein the client device is within the residence.

As shown in the figure, communication system 300 includes internet 110, cellular network 112, a residence 301, a client device 302, a gateway device 304, an external server 306, a user 308, a service provider server 315, a communication channel 310, a communication channel 312, a communication channel 313, a communication channel 314, and a communication channel 316.

Client device 302 is configured to communicate with internet 110 by way of cellular network 112, an example of which is shown by communication channel 310. Through cellular network 112, client device 302 is configured to communicate with internet 110 by way of communication channel 311. Client device 302 is additionally configured to communicate with external server 306 by way of communication channel 314 via internet 110. Gateway device 304 is configured to communicate with service provider server 315 through physical media/wiring 312, such as a coaxial network, an optical fiber network, and/or DSL, or wireless network, such as a satellite or terrestrial antenna implemented network or a combination of any of these examples or their equivalents. The data communicated on such network can be implemented using a variety of protocols on a network such as a wide area network (WAN), a virtual private network (VPN), metropolitan area networks (MANs), system area networks (SANs), a public data telephone network (PSDN), a global Telex network, or a 2G, 3G, 4G or 5G. Service provider server 315 then allows gateway device 304 to communicate with internet 110 via communication channel 313. Through internet 110, gateway device 304 is configured to communicate with external server 306 via communication channel 314.

In the non-limiting example discussed above, the gateway device is described as being configured to communicate through the internet by way of the service provider server with the external server. However, it should be noted that in some cases, the service provider server may include the external server in accordance with aspects of the present disclosure.

FIG. 4 illustrates an exploded view of client device 302, gateway device 304, and external server 306 of FIGS. 3A-B and 5A-C.

As shown in the figure, gateway device 304 includes: a controller 422, a memory 428, which has stored therein an onboarding program 430; at least one radio, a sample of which is illustrated as a radio 424, and an interface circuit 426.

In this example, controller 422, memory 428, radio 424, and interface circuit 426 are illustrated as individual devices. However, in some cases, at least two of controller 422, memory 428, radio 424 and interface circuit 426 may be combined as a unitary device. Whether as individual devices or as combined devices, controller 422, memory 428, radio 424, and interface circuit 426 may be implemented as any combination of an apparatus, a system and an integrated circuit. Further, in some cases, at least one of controller 422, memory 428, and interface circuit 426 may be implemented as a computer having a non-transitory computer-readable recording medium. A non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules maybe located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Controller 422 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of the gateway device 304 in accordance with the embodiments described in the present disclosure.

Memory 428 can store various programming, user content, and data including onboarding program 430. Onboarding program 430 includes instructions, that when executed by controller 422 enables gateway device 304 to enable gateway device 304 to be onboarded by client device 302.

Interface circuit 426 can include one or more connectors, such as RF connectors, or Ethernet connectors, and/or wireless communication circuitry, such as 5G circuitry and one or more antennas. Interface circuit 426 receives content from external server 306 (as shown in FIGS. 3A-B) by known methods, non-limiting examples of which include terrestrial antenna, satellite dish, wired cable, DSL, optical fibers, or 5G as discussed above. Through interface circuit 426, gateway device 304 receives an input signal, including data and/or audio/video content, from external server 306 and can send data to external server 306.

Radio 424 (and preferably two or more radios), may also be referred to as a wireless communication circuit, such as a Wi-Fi WLAN interface radio transceiver and is operable to communicate with client device 302 and with external server 306. Radio 424 includes one or more antennas and communicates wirelessly via one or more of the 2.4 GHz band, the 5 GHz band, 6 GHz band, and the 60 GHz band, or at the appropriate band and bandwidth to implement the Wi-Fi 4, 5, 6, or 6E protocols. Gateway device 304 can also be equipped with a radio to implement a Bluetooth interface radio transceiver and antenna, which communicates wirelessly in the ISM band, from 2.400 to 2.485 GHz. As an alternative, at least one of the radios can be a radio meeting a Radio Frequency for Consumer Electronics (RF4CE) protocol, Zigbee protocol, and/or IEEE802.15.4 protocol, which also communicates in the ISM band.

External server 306 includes a controller 402, and a memory 404, which has stored therein an onboarding program 406.

Controller 402 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of external server 306 in accordance with the embodiments described in the present disclosure.

Memory 404 can store various programming, user content, and data including onboarding program 406. Onboarding program 406 includes instructions, that when executed by controller 402 enables client device 302 to initiate onboarding of gateway device 304.

Client device 302 includes: a controller 408; a memory 414, which has stored therein an onboarding program 420; and at least one radio, a sample of which is illustrated as a radio 410; an interface circuit 412, a user interface circuit 413, a display 416, microphone 417, and a speaker 418.

In this example, controller 408, memory 414, radio 410, interface circuit 412, user interface circuit 413, display 416, and speaker 418 are illustrated as individual devices. However, in some cases, at least two of controller 408, memory 414, radio 410, interface circuit 412, user interface circuit 413, display 416, and speaker 418 may be combined as a unitary device. Further, in some cases, at least one of controller 408 and memory 414 may be implemented as a computer having tangible computer-readable media for carrying or having computer-executable instructions or data structures stored thereon.

As will be described in greater detail below, controller 408 is configured to execute instructions stored in memory 414 to cause client device 302 to transmit an onboarding instruction to external server 306 to instruct external server 306 to instruct gateway device 304 to establish a Wi-Fi network using the secure SSID, the password and the key.

As will be described in greater detail below, in some embodiments, controller 408 is configured to execute instructions stored in memory 414 to additionally cause client device 302 to receive an indication from external server 306 of the established Wi-Fi network.

As will be described in greater detail below, in some embodiments, controller 408 is configured to execute instructions stored in memory 414 to additionally cause client device 302 to play a sound, via speaker 418, corresponding to the indication of the established Wi-Fi network.

As will be described in greater detail below, in some embodiments, controller 408 is configured to execute instructions stored in memory 414 to additionally cause client device 302 to additionally cause client device 302 to receive, via microphone 417, a verbal instruction from a user to onboard gateway device 304 and transmit the onboarding instruction based on the received verbal instruction.

Controller 408 may be implemented as a hardware processor such as a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and functions of client device 302 in accordance with the embodiments described in the present disclosure.

Memory 414 can store various programming, and user content, and data including onboarding program 420. Onboarding program 420 includes instructions, that when executed by controller 408 enables client device 302 to initiate onboarding onto gateway device 304.

Interface circuit 412 can include one or more connectors, such as RF connectors, or Ethernet connectors, and/or wireless communication circuitry, such as 5G circuitry and one or more antennas. Interface circuit 412 further enables controller 408 to decode communication signals received by radio 410 from gateway device 304 and to encode communication signals to be transmitted by radio 410 to gateway device 304.

User interface circuit 413 may be any device or system that is operable to enable a user to access and control controller 408 to manually operate or configure client device 302. User interface circuit 413 may include one or more layers including a human-machine interface (HMI) machines with physical input hardware such as keyboards, mice, game pads and output hardware such as computer monitors, speakers, and printers. Additional UI layers in user interface circuit 413 may interact with one or more human senses, including: tactile UI (touch), visual UI (sight), and auditory UI (sound).

Radio 410, may include a Wi-Fi WLAN interface radio transceiver that is operable to communicate with gateway device 304, as shown in FIGS. 3A-B and also may include a cellular transceiver operable to communicate with a cellular service provider (not shown) through a cellular network. Radio 410 includes one or more antennas and communicates wirelessly via one or more of the 2.4 GHz band, the 5 GHz band, 6 GHz band, and the 60 GHz band, or at the appropriate band and bandwidth to implement the Wi-Fi 4, 5, 6, or 6E protocols. Client device 302 can also be equipped with a radio to implement a Bluetooth interface radio transceiver and antenna, which communicates wirelessly in the ISM band, from 2.400 to 2.485 GHz. As an alternative, at least one of the radios can be a radio meeting a RF4CE protocol, Zigbee protocol, and/or IEEE802.15.4 protocol, which also communicates in the ISM band.

Insofar as gateway device 304 provides connection to external server 306, such as a multiple systems operator (MSO), gateway device 304 can be equipped with connectors to connect with a television or display device, and can also include programming to execute an electronic program guide and/or other suitable graphical user interface (GUI), and can with such configuration be referred to as a so-called set top box. Such a set top box can be included in the system shown in FIGS. 3A-B as gateway device 304 or in addition thereto. Moreover, inclusion of one or more of far-field microphones, (for e.g., voice command and/or presence recognition, and/or telephone communication), cameras, (for e.g., gesture and/or presence recognition, and/or video telephone communication), and speakers, and associated programming, can enable the gateway device to be an SMD.

In the non-limiting example discussed above, the gateway device is described as being configured to communicate through the internet by way of the service provider server with the external server. However, it should be noted that in some cases, the service provider server may include the external server in accordance with aspects of the present disclosure.

Returning to FIG. 2, after the network device is turned on (S204), the network device broadcasts an open SSID (S206). An example embodiment will be discussed below in reference to FIG. 3A.

Consider the following situation: user 308 has purchased gateway device 304, unboxed it and turned it on. Gateway device 304 will then create a Wi-Fi network (not shown) associated with an open onboarding SSID. Gateway device 304 establishes the wide area network (WAN) for connection to external server 306 via service provider 315. More specifically as shown in FIG. 4, controller 422 executes instructions from onboarding program 430 to create an open SSID and then instructs radio 424 to broadcast an open onboarding SSID. Gateway device 304 broadcasts the open SSID from radio 424, and radio 410 of client device 302 receives the open SSID, which is passed to controller 408. After joining the open onboarding SSID, client device 302 is able to wirelessly communicate with gateway device 304 using the open SSID.

Returning to FIG. 2, after the network device broadcasts an open SSID (S206), a serial number and key is obtained (S208). For example, once communication has been established between client device 302 and gateway device 304, client device 302 will obtain a serial number and key by any known method, a non-limiting example includes retrieving the serial number associated with gateway device 304 from memory 428.

Returning to FIG. 2, after the serial number and key is obtained (S208), a programmed SSID is created (S210). For example, a programmed secure SSID may be created using information unique to client device 302, using information unique to user 308 of client device 302, using information unique to gateway device 304, or any combination thereof. In one non-limiting example embodiment, a programmed secure onboarding SSID is created based on the email of user 308 on client device 302, the serial number of gateway device 304, and time stamp.

Returning to FIG. 2, after a programmed SSID is created (S210), a fronthaul SSID is obtained (S212). For example, client device 302 obtains from the user the planned fronthaul SSID and its password for the home network setup. This is the fronthaul network that is now available for all devices to connect in the home network of gateway device 304.

Each of the operations discussed above (S204-S212) may be performed in a known manner, for example in U.S. application Ser. No. 16/938,305, filed on Jul. 25, 2020, the entire disclosure of which is incorporated herein by reference.

Returning to FIG. 2, after a fronthaul SSID is obtained (S212), a programmed SSID and its password, a fronthaul SSID and its password, and key are stored (S214). For example, client device 302 may store the programmed SSID, its password, fronthaul SSID, and its password, and the key in external server 306 for future use.

In some embodiments, client device 302 may store the programmed SSID and its password in gateway device 304 for future use.

For purposes of discussion, consider a situation where gateway device 304 is not operating correctly, or an update is needed, and user 308 needs to re-onboard gateway device 304. In accordance with aspects of the present disclosure, rather than starting the onboarding process from the very beginning (S204), and recreating a secure SSID (S210), user 308 can start from the created secure SSID. This will be described in greater detail below.

Returning to FIG. 2, after a programmed SSID and its password, a fronthaul SSID and its password, and key are stored (S214), the client device contacts the external server (S216). For example, as mentioned above, there may be instances wherein the network device may need to be re-onboarded, e.g., rebooted, for example in attempts to rectify faulty operations or when service upgrades are needed. Suppose, for purposes of discussion only that, for example as shown in FIG. 3A, gateway device 304 needs to be re-onboarded. In accordance with aspects of the present disclosure, gateway device 304 will not need to start from the factory default SSID, which may be known openly and therefore not secure (S204). On the contrary, in accordance with aspects of the present disclosure, the re-onbarding of gateway device 304 may start with client device 302 contacting external server 306.

Example embodiments will be described in greater detail with reference to FIGS. 3A-B, and 5A-C.

As shown in FIG. 3A, client device 302 may communicate with external server 306 by way of two distinct procedures. In a first procedure, suppose client device 302 is associated with gateway device 304 while client device 302 is within residence 301. As such client device 302 may communicate with gateway device over a wireless network via communication channel 316. In this first procedure, client device 302 may contact external server 306 via gateway device 304, to service provider server 315, to internet 110 and then to external server 306.

However, for purposes of discussion, let client device 302 have mobile service, e.g., client device 302 may be a mobile phone, and is therefore able to connect to cellular network 112 via communication channel 310. In a second procedure, client device 302 may contact external server 306 via cellular network 112, to internet 110 and then to external server 306.

It should be noted that in accordance with aspects of the present disclosure, client device 302 may contact external server 306 while not being within residence 301. For example, for purposes of discussion, suppose that user 308 is the homeowner of residence 301 and is away from home. Further suppose that a child of user 308 is home and contacts user 308 to complain that gateway device 304 is not working properly. In such a case, in accordance with aspects of the present disclosure, user 308 may contact service provider 315 to initiate re-onboarding of gateway device 304. This will be described in greater detail with reference to FIG. 3B.

FIG. 3B illustrates communication system 300 onboarding a gateway device at time t₂.

As shown in the figure, communication system 300 at time t₂ differs from time t₁ (as shown in FIG. 3A), in that at time t₂, client device 302 and user 308 are not in residence 301. In this example, client device 302 may contact external server 306 via cellular network 112, to internet 110 and then to external server 306.

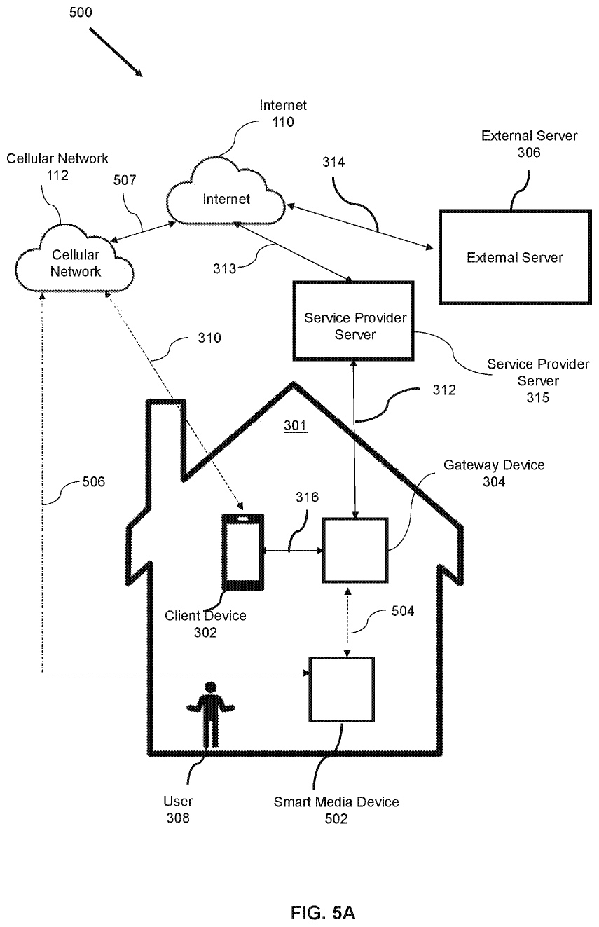

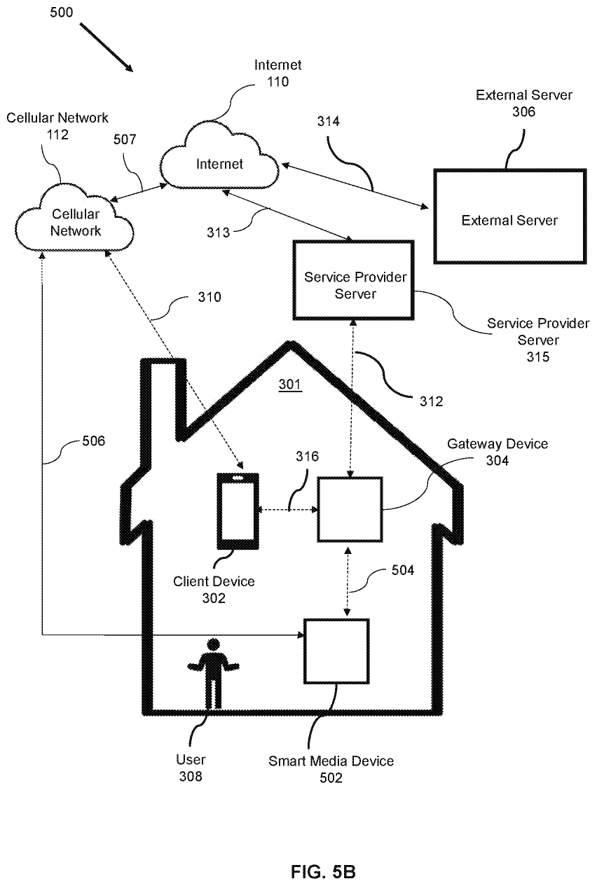

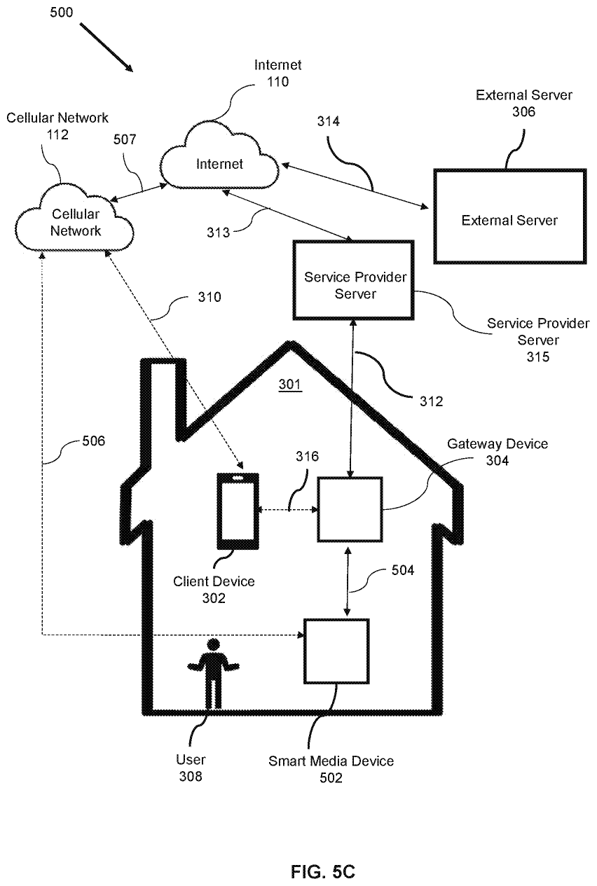

In the examples discussed above with reference to FIGS. 3A-B, the client device that initiates onboarding of the network device is a smart phone. However, in accordance with aspects of the present disclosure, an SMD alternatively take the form of a client device that initiates onboarding of the network device. Example embodiments that implement an SMD will now be described with reference to FIGS. 5A-C.

FIGS. 5A-C illustrates three different embodiments of onboarding of a gateway device in accordance with aspects of the present disclosure, at times t₃, t₄, and is respectively.

FIG. 5A illustrates a communication system 500 onboarding a gateway device at time t₃.

As shown in the figure, communication system 500 includes internet 110, cellular network 112, residence 301, client device 302, gateway device 304, external server 306, user 308, service provider server 315, an SMD 502, communication channel 310, communication channel 312, communication channel 313, communication channel 314, communication channel 316, a communication channel 504, a communication channel 506, and a communication channel 507.

In the figure, communication channels 310, 504 and 506 are illustrated with dashed lines to represent that they are optional communication channels. In particular, in the example embodiment discussed in more detail below of FIG. 5A, client device 302 initiates re-onboarding of gateway device 304 by communicating with external server 306 via communication channel 316, gateway device 304, communication channel 312, service provider server 315, communication channel 313, Internet 110, and communication channel 314.

SMD 502 may communicate with internet 110 by known methods, non-limiting examples of which include cellular network 112, an example is shown as communication channel 506, or another onboarded LAN device (not shown). Through cellular network 112, SMD 502 is able to communicate with internet 110 via communication channel 507, and then through internet 110, SMD 502 is able to communicate with external server 306 via communication channel 314. Gateway device 304 is configured to communicate with service provider server 315 via communication channel 312, which then allows gateway device 304 to communicate with internet 110 via communication channel 313. Through internet 110 gateway device 304 is configured to communicate with external server 306 via communication channel 314. As previously mentioned, client device 302 is configured to communicate with cellular network 112 via communication channel 310 which then allows client device 302 to communicate with internet 110 via communication channel 507. Through internet 110, client device 302 is able to communicate with external server 306 via communication channel 314.

At time t₃, either client device 302 or SMD 502 may initiate re-onboarding of gateway device 304 in accordance with aspects of the invention. If client device 302 is used, then the initiation may be performed as discussed above with reference to FIGS. 3A-B. However, instances where SMD 502 is used to initiate re-onbarding of gateway device 304 will be described with reference to FIGS. 5B-C.

FIG. 5B illustrates a communication system 500 onboarding a gateway device at time t₄.

In the figure, communication channels 310, 504, 316, and 312 are illustrated with dashed lines to represent that they are optional communication channels. In particular, in the example embodiment discussed in more detail below of FIG. 5B, SMD 502 initiates re-onboarding of gateway device 304 by communicating with external server 306 via communication channel 506, cellular network 112, communication channel 507, Internet 110, and communication channel 314.

As mentioned previously, SMD 502 may communicate with internet 110 by known methods, non-limiting examples of which include cellular network 112, an example is shown as communication channel 506, or another onboarded LAN device (not shown). Through cellular network 112, SMD 506 is able to communicate with internet 110 via communication channel 507, and then through internet 110, SMD 502 is able to communicate with external server 306 via communication channel 314. Gateway device 304 is configured to communicate with service provider server 315 via communication channel 312, which then allows gateway device 304 to communicate with internet 110 via communication channel 313. Through internet 110 gateway device 304 is configured to communicate with external server 306 via communication channel 314.

In this example embodiment, SMD 502 initiates re-onboarding of gateway device 304 through cellular network 112. However, in alternate embodiments, SMD 502 may initiate re-onboarding of gateway device 304 by way of gateway device 304. This will be described in greater detail with reference to FIG. 5C.

FIG. 5C illustrates a communication system 500 onboarding a gateway device at time ts.

In the figure, communication channels 310, 506, and 316 are illustrated with dashed lines to represent that they are optional communication channels. In particular, in the example embodiment discussed in more detail below of FIG. 5C, SMD 502 initiates re-onboarding of gateway device 304 by communicating with external server 306 via communication channel 504, gateway device 304, communication channel 312, service provider server 315, communication channel 313, Internet 110, and communication channel 314.

As mentioned previously, SMD 502 may communicate with internet 110 by known methods, non-limiting examples of which include cellular network 112, an example is shown as communication channel 506, or another onboarded LAN device (not shown). SMD 502 is able to communicate with external server through gateway device 304 via communication channel 312. Gateway device 304 is configured to communicate with service provider server 315 via communication channel 312, which then allows gateway device 304 to communicate with internet 110 via communication channel 313. Through internet 110 gateway device 304 is configured to communicate with external server 306 via communication channel 314.

Consider the following situation with reference to FIG. 3B, gateway device 304 is not operating correctly and must be re-onboarded while user 308 is not currently in residence 301. Client device 302 is able to contact external server 306 with an onboarding request via internet 110 by way of cellular network 112.

In some embodiments, as shown in FIG. 3A, client device 302 may contact external server 306 through gateway device 304 rather than using cellular network 112.

In some embodiments, the onboarding process may be initiated by SMD 502 as shown in FIG. 5B. Initiation of the re-onboarding process will begin with SMD 502 receiving verbal instruction from user 308, a non-limiting example of which may be “re-onboard gateway device”. This will cause SMD 502 to contact external server 306 based on the received verbal instruction. SMD 502 is able to contact external server 306 with an onboarding request via internet 110 by way of cellular network 112.

In some embodiments, as shown in FIG. 5C, SMD 502 may contact external server 306 through gateway device 304 rather than using cellular network 112.

Returning to FIG. 2, after the client device contacts the external server (S216), the external server identifies the device based on account information (S218). For example, external server 306 may identify client device 302 based on provided account information from user 308 such as a serial number and key of gateway device 304. This operation authenticates the device requesting to re-onboard gateway device 304, thus ensuring that only a trusted device may initiate the process.

Returning to FIG. 2, after the external server identifies the device based on account information (S218), the external server connects to the network device and completes onboarding (S220). For example, as shown in FIG. 5A, gateway device 304 connects to external server 306 via interne 110 by wat of service provider server 315.

Returning to FIG. 2, after the external server connects to the network device and completes onboarding (S220), the client device notifies the user of onboarding status (S222). For example, returning to FIG. 4, display 416 of client device 302 may display a message to user 308 that onboarding was either successful or not successful.

Returning to FIG. 2, after the client device notifies the user of onboarding status (S222), algorithm 200 stops (S224).

In the non-limiting example embodiments discussed above, the gateway device is described as being onboarded. It should be noted that any network device may be onboarded in accordance with aspects of the present disclosure.

In a conventional system and method for onboarding a network device, a client device is used to facilitate the onboarding process. The client device, for example a smart phone, initiates the network device to start the onboarding process. Once the onboarding process is complete, the client device is able to connect to the wireless network via the network device. The conventional onboarding process is open as well as insecure which may pose a significant threat to security. Additionally, with multiple interaction points, the onboarding process may be difficult and time consuming for the user. Also, the user is unable to initiate onboarding of devices from outside of the home if needed.

In accordance with the present disclosure, a system and method is provided for re-onboarding a currently onboarded network device using a programmed SSID remotely, or by way of an SMD. Another component includes the client device, which could either connect to the network device locally while at home or connect to the external server remotely while not at home. In either of the cases, the same instructions would be provided to perform the onboarding process. In the case when the client device will be away from home and thus away from the SMD, the onboarding of the network device would need to happen without direct voice commands to the SMD but instead from the client device.

Thus, the present disclosure as disclosed increases security during the onboarding process that may be completed either locally or remotely, while also being a timely and user friendly process.

The foregoing description of various preferred embodiments have been presented for purposes of illustration and description. It is not intended to be exhaustive or to limit the present disclosure to the precise forms disclosed, and obviously many modifications and variations are possible in light of the above teaching. The example embodiments, as described above, were chosen and described in order to best explain the principles of the present disclosure and its practical application to thereby enable others skilled in the art to best utilize the present disclosure in various embodiments and with various modifications as are suited to the particular use contemplated. It is intended that the scope of the present disclosure be defined by the claims appended hereto.

What is claimed is:

1. A client device for use with a Wi-Fi access point device, an external network, and an external server, the Wi-Fi access point device having a secure SSID, a password, and a key and being configured to access the external network, the external server having the secure SSID, the password, and the key stored therein, said client device comprising:
a memory; and
a processor configured to execute instructions stored on said memory to cause said client device to transmit an onboarding instruction to the external server to instruct the external server to instruct the Wi-Fi access point device to establish a Wi-Fi network using the secure SSID, the password and the key.

2. The client device of claim 1, wherein said processor is configured to execute instructions stored on said memory to additionally cause said client device to receive an indication from the external server of the established Wi-Fi network.

3. The client device of claim 2, further comprising:
a speaker,
wherein said processor is configured to execute instructions stored on said memory to additionally cause said client device to play a sound, via the speaker, corresponding to the indication of the established Wi-Fi network.

4. The client device of claim 1, further comprising:
a microphone,
wherein said processor is configured to execute instructions stored on said memory to additionally cause said client device to:
receive, via said microphone, a verbal instruction from a user to onboard the Wi-Fi access point device; and
transmit the onboarding instruction based on the received verbal instruction.

5. A method of using a client device with a Wi-Fi access point device, an external network, and an external server, the Wi-Fi access point device having a secure SSID, a password, and a key and being configured to access the external network, the external server having the secure SSID, the password, and the key stored therein, said method comprising:
transmitting, via a processor configured to execute instructions stored on a memory, an onboarding instruction to the external server to instruct the external server to instruct the Wi-Fi access point device to establish a Wi-Fi network using the secure SSID, the password and the key.

6. The method of claim 5, further comprising receiving, via the processor, an indication from the external server of the established Wi-Fi network.

7. The method of claim 6, further comprising playing, via a speaker, a sound corresponding to the indication of the established Wi-Fi network.

8. The method of claim 5, further comprising:
receiving, via a microphone, a verbal instruction from a user to onboard the Wi-Fi access point device; and
transmitting, via the processor, the onboarding instruction based on the received verbal instruction.

9. A non-transitory, computer-readable media having computer-readable instructions stored thereon, the computer-readable instructions being capable of being read by a processor in a client device for use with a Wi-Fi access point device, an external network, and an external server, the Wi-Fi access point device having a secure SSID, a password, and a key and being configured to access the external network, the external server having the secure SSID, the password, and the key stored therein, wherein the computer-readable instructions are capable of instructing the processor to perform the method comprising:
transmitting, via the processor configured to execute instructions stored on a memory, an onboarding instruction to the external server to instruct the external server to instruct the Wi-Fi access point device to establish a Wi-Fi network using the secure SSID, the password and the key.

10. The non-transitory, computer-readable media of claim 9, wherein the computer-readable instructions are capable of instructing the processor to perform the method further comprising receiving, via the processor, an indication from the external server of the established Wi-Fi network.

11. The non-transitory, computer-readable media of claim 10, wherein the computer-readable instructions are capable of instructing the processor to perform the method further comprising playing, via a speaker, a sound corresponding to the indication of the established Wi-Fi network.

12. The non-transitory, computer-readable media of claim 9, wherein the computer-readable instructions are capable of instructing the controller to processor the method further comprising:
receiving, via a microphone, a verbal instruction from a user to onboard the Wi-Fi access point device; and
transmitting, via the processor, the onboarding instruction based on the received verbal instruction.
